(19) United States
(12) Patent Application Publication
(10) Pub. No.: US 2015/0363569 A1
(43) Pub. Date: Dec. 17, 2015

(54) CUSTOMIZING PERSONALIZED PATIENT CARE PLANS TO FACILITATE CROSS-CONTINUUM, MULTI-ROLE CARE PLANNING

(71) Applicant: CERNER INNOVATION, INC., Kansas City, KS (US)

(72) Inventors: HUGH H. RYAN, LEE'S SUMMIT, MO (US); PAMELA M. BAKER, OLATHE, KS (US); JACLYNNE L. AAGESEN, PARKVILLE, MO (US)

(21) Appl. No.: 14/302,836

(22) Filed: Jun. 12, 2014

(51) Int. Cl. G06F 19/00

(52) U.S. Cl. CPC G06F 19/3443

(57) ABSTRACT

The present invention is directed to, among other things, providing a personalized patient care plan that is customizable based on a healthcare role associated with a user and that is shared among a plurality of healthcare providers associated with a plurality of healthcare venues. In one aspect, healthcare data associated with the patient is received from the plurality of healthcare providers associated with the plurality of healthcare venues. Based on a healthcare role associated with a user, a set of the healthcare data that is relevant to the user may be extracted. The set of the healthcare data may be populated as a set of care plan items in the personalized care plan for the patient. This personalized care plan may then be presented to the user.

### BACKGROUND

Patient care among multiple healthcare venues and multiple healthcare providers can be fragmented, fractured, inconsistent, repetitive, and confusing. This may be partially attributed to the fact that patient information is not always effectively shared among various providers and venues, or even with the patient, himself. As a result of this inconsistent and ineffective sharing, information needed for patient treatment may be outdated, unnecessarily repeated, or missed altogether.

Furthermore, healthcare-related data for a single patient accumulates with each healthcare event. Thus, an individual patient may become associated with a significant amount of healthcare data over the course of the patient's lifetime. A particular healthcare provider may find only a portion of this data relevant to the provider's treatment of the patient, but identifying and obtaining this relevant portion may be challenging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief, and at a high level, the present invention is directed to providing a personalized patient care plan that is customizable based on a healthcare role associated with a user. The personalized care plan may be shared among a plurality of healthcare providers associated with a plurality of healthcare venues. Providing this personalized care plan may include receiving healthcare data associated with a patient, where the healthcare data are received from the plurality of healthcare providers associated with the plurality of healthcare venues. A healthcare role associated with a user may be determined, where the healthcare role corresponds to a relationship between the user and the patient. Based on the healthcare role associated with the user, a set of the healthcare data that is relevant to the user may be extracted. Extracting the set that is relevant to the user may include extracting the set that is relevant to treatment of the patient by the user. Such extraction may further be based on a predefined content preference associated with the healthcare role associated with the user, a content preference associated with the particular user, and/or a set of best practices based on a condition associated with the patient, where the set of best practices is to be implemented by the user. In embodiments, extracting relevant data is based not only on the healthcare role associated with the user, but also on an identity of the patient, a patient history associated with the patient, a current healthcare event associated with the patient, and a current healthcare venue associated with the current healthcare event. After the set of the relevant healthcare data has been extracted, such data may be populated as a set of care plan items in the personalized care plan for the patient. The personalized care plan may then be presented to the user.

The personalized care plan may also be dynamic in nature. As updated healthcare data are received for a patient, the set of care plan items included in the personalized care plan may be updated, based on the updated healthcare data, to generate an updated personalized care plan. The updated healthcare data and corresponding care plan items may be reconciled with previous healthcare data and corresponding care plan items to ensure the updated care plan items presented to a user are not repetitive and/or contradictory with respect to the preexisting care plan items. This dynamically-updated care plan may be shared with a plurality of healthcare providers associated with a plurality of healthcare venues.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system that is suitable to implement embodiments of the present invention;

FIG. 3 is an exemplary care management interface illustrating a personalized care plan for a patient, where the care plan has been customized for a user that is the patient's primary care physician, in accordance with an embodiment of the present invention;

FIG. 4 is an exemplary care management interface illustrating a personalized care plan for a patient, where the care plan has been customized for a user that is the patient's care manager, in accordance with an embodiment of the present invention;

FIG. 5 is an exemplary care management interface illustrating a personalized care plan that has been customized for presentation to a patient, in accordance with an embodiment of the present invention;

FIG. 6 is a flow diagram of an exemplary method for providing a personalized care plan for a patient, where the care plan is customizable based on a healthcare role associated with a user, in accordance with an embodiment of the present invention; and

FIG. 7 is a flow diagram of an exemplary method for providing a personalized care plan for a patient, where the care plan is customized for a user that is associated with a care manager role for the patient, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for providing a personalized patient care plan that is customizable based on a healthcare role associated with a user. At a high level, a care plan is a plan for the medical care of a patient, including details regarding a patient's healthcare-related needs. The care plan may be linked, such as electronically linked, to a patient's personal health record (PHR) and/or electronic medical record (EMR). Embodiments of the present invention provide a personalized care plan for a particular patient, which may account for, among other things, the particular patient's unique attributes, medical history, current healthcare events, relationship with a particular healthcare venue and/or healthcare provider, as well as any other number of factors associated with the particular patient. The information needed to compile this type of personalized care plan might not be associated with a single healthcare provider, or even a single healthcare venue. More likely, this information has been recorded over the course of the patient's lifetime by many different healthcare providers associated with many different healthcare venues. Thus, information across multiple healthcare providers and multiple healthcare venues may need to be aggregated in order to compile a comprehensive longitudinal record for the patient, which includes healthcare data for the patient that has accumulated over time. Once aggregated, that information may be leveraged to create a personalized care plan for the patient. This personalized care plan may then be shared across multiple healthcare providers and multiple healthcare venues to provide a unified and consistent plan for care of the particular patient. Accordingly, consistent and accurate care may be provided across multiple healthcare providers and multiple healthcare venues.

The personalized care plan may include various care plan items corresponding to various items of healthcare data. Each care plan item may be based on healthcare data for the particular patient, healthcare data for a patient population segment to which the particular patient belongs, as well as generally available healthcare data that may or may not be specific to any patient or patient population segment (e.g., general best practices). Thus, the number of care plan items that could potentially be included in a patient care plan may be quite large. As can be imagined, for a patient experiencing complex medical problems over an extended period of time, a presentation including all of these potential care plan items may be overwhelming to the user.

While each item of healthcare data may be relevant to some healthcare provider's treatment of the patient, for one particular healthcare provider, only a portion of this data may be useful in treating the patient. In other words, of the tremendous amount of patient data available, only a few specific pieces of data may be relevant to the particular healthcare provider's treatment of the patient. As used herein, “treatment” may refer to any number of healthcare-related services provided by a healthcare provider to a patient, such as examinations, diagnostics, medical procedures, testing, rehabilitation, consultations, care management, and the like. The relevance of various items of healthcare data with respect to treatment of a patient may depend, in part, on a healthcare role associated with the healthcare provider. For example, the healthcare data that are relevant to treatment of a patient by a physician in an emergency room may be different from the healthcare data that are relevant to treatment of the patient by a primary care physician, which may be different from the healthcare data that are relevant to treatment of the patient by a nurse in a long-term care facility, which may be further different from the healthcare data that are relevant to treatment of the patient by a care manager. For instance, a radiologist treating a patient may be interested in healthcare data relating to both past and present radiology records. By contrast, the patient's primary care physician might not find old radiology records particularly relevant to the physician's treatment of the patient, and may instead be interested in healthcare data corresponding to patient symptoms reported over a certain period of time, past and present medications prescribed for the patient, reactions to such medications, general allergy information, and the like. Thus, as illustrated by this example, and as will be explained in greater detail below, the presentation of the personalized patient care plan, and the care plan items included therein, may be customized according to a healthcare role associated with a particular healthcare provider.

This personalized patient care plan that is customized for a particular healthcare provider includes a context-specific plan for care of the patient. This context-specific plan offers benefits in addition to those provided by a condition-specific care plan. A condition-specific care plan might account only for the current state of the patient, or the current condition for which the patient is being treated. The personalized, customizable care plan of the present invention accounts not only for the current condition of the patient, but as explained above, also accounts for any number of other factors that are likely to be relevant to the particular healthcare provider treating the particular patient at a particular time. In this way, every healthcare provider receives a contextual presentation of the care plan, which includes a consolidated cross section of relevant content, in addition to content pertaining to a current condition of the patient.

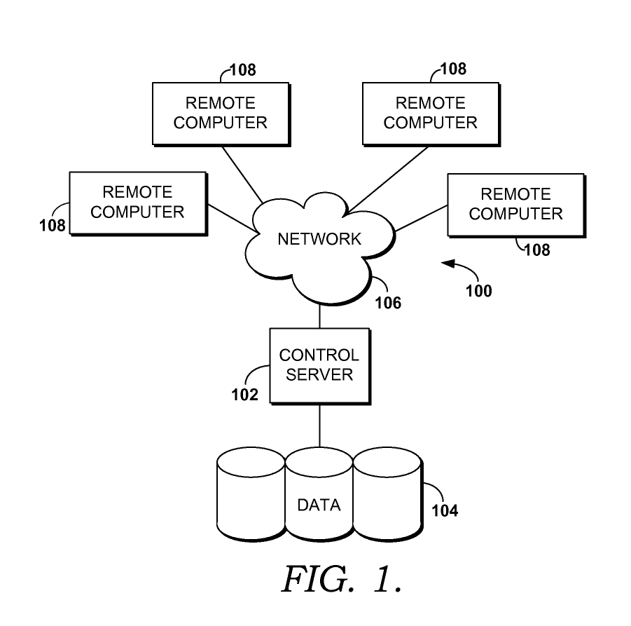

Turning now to the figures, an exemplary computing environment suitable for use in implementing embodiments of the present invention is described. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, a user might enter commands and information into the control server 102 or convey the commands and information to the control server 102 via one or more of the remote computers 108 through input devices, such as a keyboard, a microphone (e.g., voice inputs), a touch screen, a pointing device (commonly referred to as a mouse), a trackball, or a touch pad. Other input devices may include, without limitation, microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

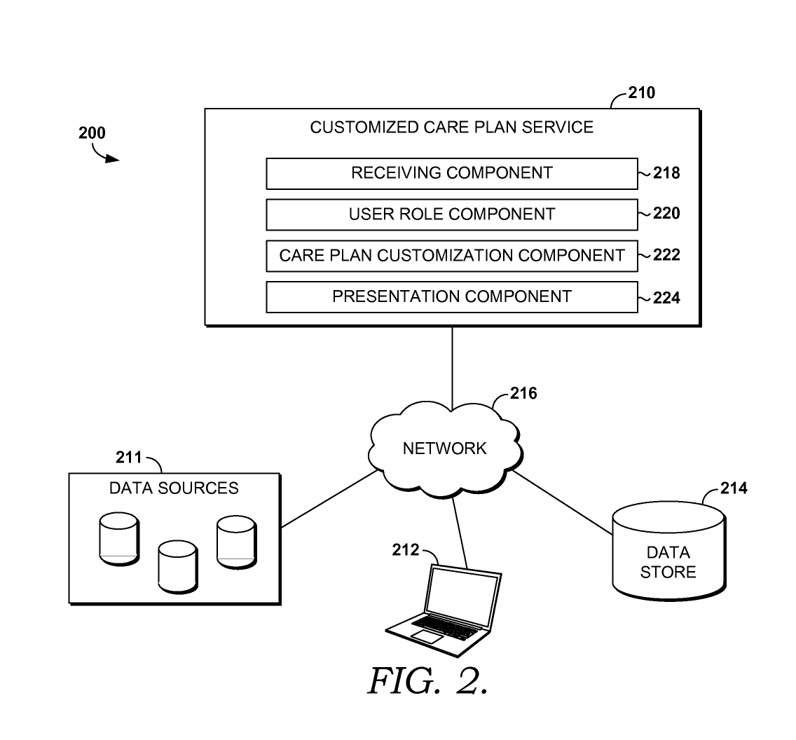

Turning now to FIG. 2, a block diagram of an exemplary computing system environment 200 suitable to implement embodiments of the present invention is illustrated. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The exemplary computing system environment 200 includes a customized care plan service 210, which, in embodiments, provides a personalized patient care plan that is customizable based on a healthcare role associated with a user. The computing system environment 200 further includes a plurality of data sources 211, a user computing device 212, and a data store 214. All of these components are in communication with one another via a network 216. The network 216 may resemble the network 106 of FIG. 1 and may include, without limitation, one or more local area networks (LANs) or wide area networks (WANs). The network 216 may further include a cloud computing network, such as a public cloud, a private cloud, or a dedicated cloud. These cloud computing networks may be referred to as “the cloud.” Such networks are commonplace and, as such, will not be further described herein.

It will be understood and appreciated that the computing system environment 200 shown in FIG. 2 is merely an example of one suitable computing system environment and is not intended to suggest any limitation as to the scope of use or functionality of embodiments of the present invention. Neither should the components included in the computing system environment 200 be interpreted as having any dependency or requirement related to any single component or combination of components illustrated therein. Additionally, while FIG. 2 depicts a single user computing device 212 and a single data store 214, it will be understood that, in embodiments, any number of these components may be included in the computing system environment 200. For example, any number of physical machines (such as remote computers or portion of remote computers 108 shown in FIG. 1), virtual machines, data centers, endpoints, or combinations thereof may be employed to achieve the desired functionality within the scope of embodiments of the present invention.

As mentioned, in embodiments, the customized care plan service 210 provides a personalized patient care plan that is customizable based on a healthcare role associated with a user. The healthcare data used to create the personalized patient care plan may originate from a variety of different entities or data sources. As shown in the computing system environment 200, a number of different entities or data sources, such as the plurality of data sources 211, may communicate with other components included in the computing system environment 200 via the network 216. The plurality of data sources 211 may include any number of healthcare providers and/or healthcare venues. For example, any one of the plurality of data sources 211 may be a hospital, a physician's office, a health information exchange, a pharmacy, a walk-in clinic, a rehabilitation facility, a research facility, a public health agency, an urgent care clinic, and the like. The data sources 211 may further include any number of healthcare providers associated with those healthcare venues. Such healthcare providers include, for example, care managers, treating physicians, specialists (e.g., surgeons, radiologists, cardiologists, and oncologists), emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. In other words, the data sources 211 may include any healthcare provider and/or any healthcare venue that collects and/or has access to any type of healthcare information.

These data sources provide healthcare data, which may include any type of healthcare information. For example, healthcare data may be specific to a single patient or a group of patients. It may include information that describes various aspects of the patient's past or present state, including patient vitals, lab results, medication orders, diagnosis codes, condition codes, clinical orders, indexed values from clinical notes or other text documents, patient demographic information, patient history, patient images, and a variety of other patient information. As can be imagined, healthcare data may result from each healthcare-related event (e.g., doctor's office appointment, surgery, procedure, specialist consultation, walk-in clinic visit) experienced by a patient. For example, suppose a physician (e.g., one data source of the plurality of data sources 211) orders a prescription for a patient. Healthcare data for that event may include a prescription name, dose, frequency, duration, special instructions, and any other data associated with the order. Similarly, healthcare data relating to a surgical procedure may include a description of the procedure, medications prescribed after the procedure, a follow-up appointment, and any number of other items stemming from the procedure.

Additionally, healthcare data may be generally available healthcare data that may or may not be specific to any particular patient or group of patients. For example, healthcare data may include data for patient population segments, which include similarly-situated patients. Furthermore, healthcare data may include healthcare-related standards of care, best practices, research, and statistics published by a private or public health agency.

All such healthcare data, including data received from the plurality of data sources 211, as well as any other healthcare data received and/or generated, may be stored at the data store 214. For example, one or more of the plurality of data sources 211 may compile and/or maintain EMRs for patients. These individual EMRs and the data included therein may be stored at the data store 214. In this way, the healthcare data included in multiple EMRs maintained by multiple healthcare venues for a single patient may be aggregated, stored, and leveraged to compile a longitudinal EMR for the patient, which may also be stored at the data store 214. Additionally, data store 214 may store PHRs for patients.

As illustrated by the discussion of healthcare data above, a single patient may be associated with a tremendous amount of healthcare data. Because a particular healthcare provider may not need to review all of this data for purposes of treating the patient, it may be beneficial to customize the presentation of the data in the care plan according to a particular healthcare provider and/or a particular healthcare provider role. Such customization will now be discussed with respect to FIG. 2.

As shown in FIG. 2, the customized care plan service 210 includes a receiving component 218, a user role component 220, a care plan customization component 222, and a presentation component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the remote computer 108 of FIG. 1. It will be understood that the components 218, 220, 222, and 224 illustrated in FIG. 2 are exemplary in nature and in number and should not be construed as limiting. Any number of components may be employed to achieve the desired functionality within the scope of embodiments hereof.

The receiving component 218 may receive healthcare data associated with a particular patient. As mentioned, this healthcare data may be received from multiple healthcare providers and multiple healthcare venues, such as the plurality of data sources 211. All such healthcare data may be stored in the data store 214, which is in communication with the receiving component 218 via the network 216.

The user role component 220 may determine a healthcare role associated with a user, where the healthcare role corresponds to a relationship between the user and the patient. The role may be determined by roles or rights assigned to a user's login credentials or to a position or title associated with the user. The role may further be influenced by a variety of factors. For example, a user role may vary according to a location, such as a particular area of a single healthcare venue or a particular healthcare venue among a plurality of healthcare venues. For example, a user may have different roles depending on the particular unit within the healthcare venue at which the user is located. A nurse may be associated with one nursing role while working in a critical care unit, and that same nurse may be associated with a different nursing role while working in a diagnostic imaging unit. The location and corresponding role may be determined in a variety of manners, such as a user badge with RFID capabilities. The user's badge may be associated with the identity of the user, and may further enable location tracking of the user, such that a user role may be determined based on an identity and location of the user. Additionally or alternatively, a particular device at which the user enters login credentials may be associated with a particular location in the healthcare venue. For example a workstation computer may be associated with a relatively fixed location. When a user enters login credentials at the workstation, the role associated with the user may be determined based upon the user's credentials and the location of the workstation at which the user has provided his credentials. A user may further have different roles depending on the particular venue (that may be part of a related or commonly managed network of healthcare venues) within which the user is making rounds.

The user may have a single healthcare role across all patients, or the user's healthcare role may vary from patient to patient. For example, a user specializing in radiology may be associated with a radiologist role across all patients, because that user's relationship with patients may always be that of a radiologist treating and/or diagnosing the patients. By contrast, however, a user may be associated with a primary care physician role for one patient, yet associated with a consulting physician role for another patient. Similarly, a user might work as a nurse at a hospital and also as a care manager. The user would be associated with a nurse role with respect to hospital patients, but with respect to the user's care management clients, the user would be associated with a care manager role. Furthermore, a user might be associated with multiple roles with respect to a single patient. The role associated with a user with respect to a particular patient may be determined based on different login credentials associated with different patients, or the user's relationship with respect to the patient may be provided to the user role component 220. For example, a patient's care team, including titles for members of the patient's care team that define the member's relationship with respect to the patient (e.g., primary care physician, care manager) may be defined and provided to the user role component 220.

Based on the healthcare role associated with the user, the care plan customization component 222 may extract the set of healthcare data that is relevant to the user. For example, such healthcare data may be relevant to treatment of the patient by the user. The healthcare data may then be populated as care plan items in the personalized patient care plan. In this way, the care plan may be customized to include care plan items corresponding to the healthcare data that are likely to be the most relevant and/or useful to a particular healthcare provider in treating a particular patient. The presentation component 224 may then present to the user the personalized patient care plan that has been customized for the user. Such presentation may occur at the user computing device 212. In embodiments, the care plan customization component 222 transforms the raw healthcare data into care plan items that are appropriate for presentation to a user. This may include revising, formatting, combining, breaking down, or otherwise transforming the raw data into a form that is easily understood by a user.

The determination and extraction of healthcare data that is relevant to the user may be accomplished in a number of manners. For example, activity at user devices, such as user computing device 212, which are in communication with the network 216 may be monitored and analyzed. Based on observed patterns and trends across all users associated with a variety of healthcare roles, it may be determined that a particular set of healthcare data is especially relevant to a particular type of healthcare provider. Further patterns and trends may be identified and analyzed to determine other factors that may bear on the relevance of an item of healthcare data to a user. Continuous monitoring and analysis may be performed to develop the logic implemented at the customized care plan service 210. Additionally, as care plan items are automatically presented to a user, and as the user accepts, rejects, and/or modifies the automatically presented items, and/or as the user manually selects new and/or different care plan items for display, such information may be used to refine the logic implemented at the customized care plan service 210. In this way, the customized care plan service 210 may include machine-learning capabilities.

As mentioned, in embodiments, the determination of relevance is based on factors in addition to a healthcare role associated with a user, such as the patient's identity, medical history, current healthcare event, and current healthcare venue. For instance, a nurse may provide care to hospital patients at a hospital and may also administer flu shots at a walk-in clinic. The determination of relevant healthcare data may be based not only on the healthcare role associated with the nurse, but also on the current healthcare venue (e.g., hospital vs. walk-in clinic) and current healthcare event (e.g., emergency event vs. routine administration of a vaccine). Similarly, if a patient is admitted to a hospital for a serious illness, then healthcare data pertaining to occurrences of serious illnesses in the patient's medical history may be deemed relevant to a particular user treating the patient at that particular time. By contrast, healthcare data pertaining to treatment for a broken arm during the child's youth may be determined not to be relevant to the particular user treating the patient at that particular time.

Further determinations of relevance may be based on a patient's medical history. If a patient has a long history of complicated medical problems, many of which are related to one another, then healthcare data pertaining to those occurrences in the patient's medical history may be deemed relevant. On the other hand, if the patient's medical history includes a small number of relatively minor and/or common healthcare-related events (e.g., common cold), then healthcare data relating to those occurrences may not be deemed relevant to treatment of the patient by any user.

As can be imagined, the determination of relevant healthcare data need not be based on a single factor. Rather, the determination may be based on a combination of factors. For example, suppose a user associated with a nursing role is administering a flu shot. In this instance, the nurse may wish to review care plan items corresponding to healthcare data pertaining specifically to previously-administered flu shots, reactions to such shots, allergy information that is especially relevant to determining whether to administer a flu shot, past and present illnesses that are relevant to determining whether to administer a flu shot, as well as any other information that may be relevant to the nurse's administration of the vaccine. The nurse may wish to view an entirely different set of care plan items for a different patient, such as a patient visiting an emergency room with a broken arm. Thus, as illustrated by this example, the presentation of the personalized patient care plan and the care plan items included therein may be customized according not only to a particular user's healthcare role, but also to a current healthcare event, healthcare venue, medical history, and any other number of factors.

Further determinations of relevance may be based on a patient population segment to which a particular patient belongs. For example, it may be determined that the patient has diabetes, and as such, that the patient belongs to a patient population segment having diabetes. Certain healthcare data may be determined to be generally relevant to the care of patients belonging to that segment. A personalized care plan for the patient may then be populated with care plan items corresponding to this healthcare data. Even more specific population segments may be identified. For example, if in addition to having diabetes, the patient also has high blood pressure and has undergone an amputation procedure, it may be determined that the patient belongs to a patient population segment having diabetes, a patient population segment having high blood pressure, a patient population segment having undergone an amputation procedure, and a patient population segment associated with any combination of these three items, including a patient population segment associated with all three. In this way, relevant healthcare data may be identified based not only on patient-specific information (e.g., the patient has diabetes and high blood pressure, and has also undergone an amputation), but also on non-patient-specific information (e.g., care plan items that are generally relevant to patients associated with diabetes, high blood pressure, and an amputation).

Other non-patient specific information, such as general best practices information, may be determined to be relevant to a healthcare provider's treatment of a patient. This information may be derived from any number of research institutions, health agencies, or other healthcare information sources. In some instances, the best practices may be based on a particular condition associated with a patient. In other instances, certain best practices may be applicable to almost all patients (e.g., an annual flu shot might be a best practice that is applicable with almost all patients, independent of any particular condition associated with the patient). The best practices that are deemed relevant to a user may be limited to those best practices that will actually be implemented by the user. For example, a set of best practices may indicate that a patient should not eat or drink for a specified period of time preceding a surgical procedure. A care plan item corresponding to this best practice might be presented to the patient's care manager, as well as healthcare providers involved in the surgical procedure, but might not be presented to the patient's primary care physician, if the primary care physician will play no role with respect to the surgical procedure. Thus, specific care plan items may be presented to the users that will actually take action with respect to the care plan items.

Additional non-patient-specific information that may influence a determination of relevance includes content preference information. Such preference information may be associated with a particular role and/or a particular user. For example, by monitoring and analyzing user activity over time, it may be determined that primary care physicians, as a general group, prefer to view certain care plan items, or certain content within care plan items, during treatment of patients. Similarly, it may be determined that care managers, as a general group, prefer to view other care plan items or specific content therein. These preferences may be taken into account by the care plan customization component 222 when extracting relevant healthcare data that are to be populated as care plan items in the customized care plan. It may further be determined that an individual user has certain content preferences. For example, over time, it may be observed that an individual repeatedly navigates to a certain care plan item and/or type of care plan item. The care plan customization component 222 may then learn that the individual has a content preference for that care plan item. In this way, predefined content preferences for users associated with a particular healthcare role, as well as predefined content preferences for individual users, may be assessed and relied upon in determining healthcare data and corresponding care plan items that are relevant to the user. The predefined content preferences may be stored at data store 214, which may be accessed by the customized care plan service 210 via the network 216.

In further embodiments, a particular healthcare venue may set its own standards for relevance. For example, a particular venue might specify that predefined categories of healthcare data are relevant to particular users within that venue. For instance, severe allergy information may be specified as being relevant to users associated with any healthcare role within that venue. A healthcare venue might further specify certain types of data that should be deemed relevant to certain types of users. All of this venue-specified information may also be stored at data store 214.

As evidenced by the discussion above, the personalized patient care plans of the present invention enable the efficient communication of the right information to the right person at the right time. This efficient communication of meaningful content is important to ensure that a patient receives care based on the most timely and relevant information available.

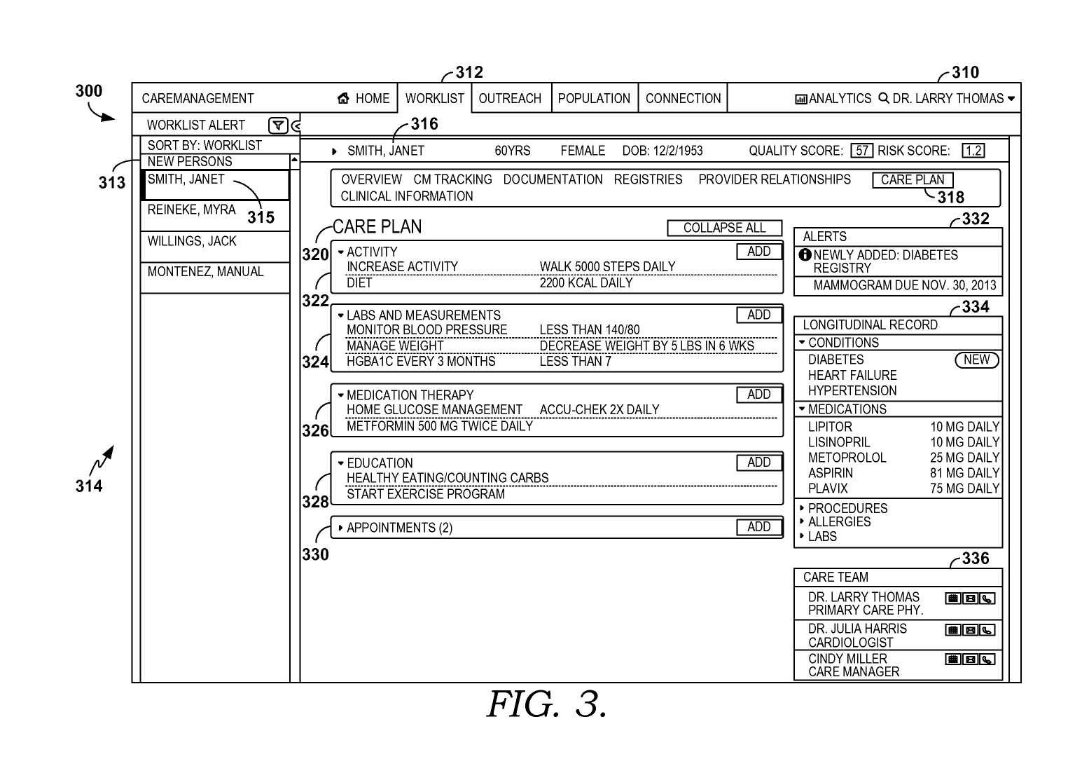

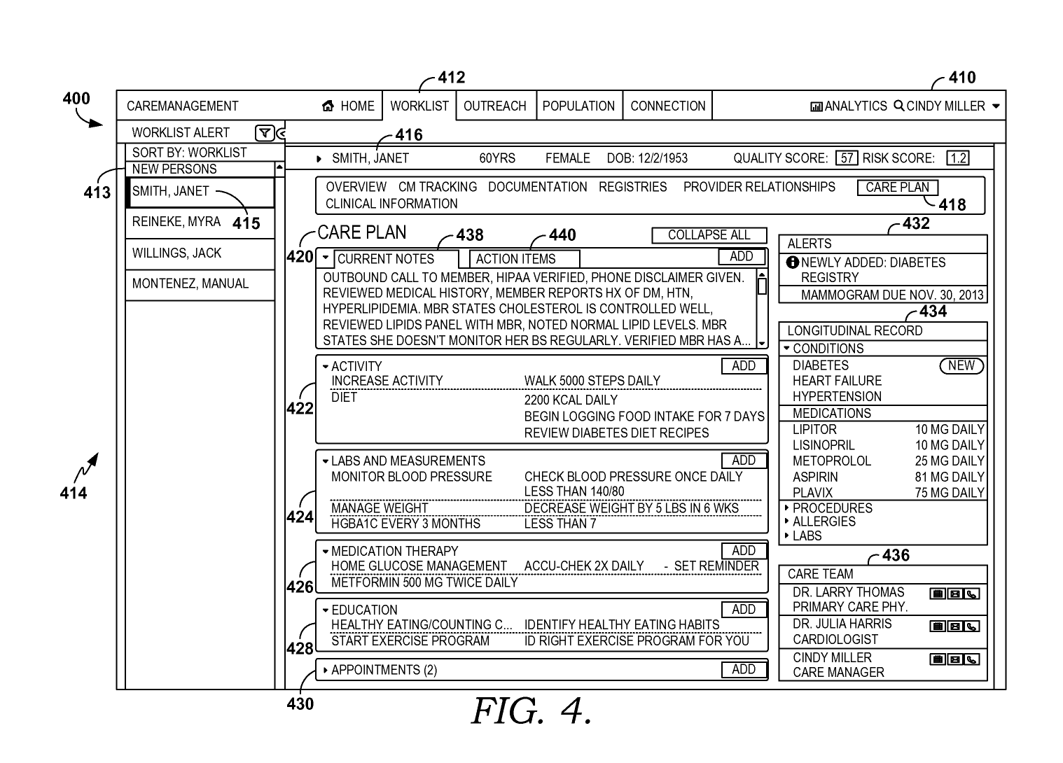

Turning now to FIG. 3 and FIG. 4, exemplary care management interfaces 300 and 400, respectively, illustrate a personalized care plan for a patient. The care plan included in both care management interface 300 and care management interface 400 is personalized for the same patient, Janet Smith. But the care plan 320 included in the care management interface 300 has been customized for Janet Smith's primary care physician, Dr. Larry Thomas, while the care plan 420 included in the care management interface 400 has been customized for Janet Smith's care manager, Cindy Miller. Thus, exemplary ways in which a personalized patient care plan may be customized for a particular user and/or a particular role associated with a user may be understood with respect to FIGS. 3-4.

Beginning with an overview of the care management interface 300, a user login indication 310 shows that a user has logged in as Dr. Larry Thomas. The user has selected a worklist tab 312, which causes a worklist display area 314 to be displayed. Within this worklist display area 314 is a list of new persons 313 associated with Dr. Larry Thomas. Janet Smith has been selected, as indicated by the reference numeral 315, and as a result, patient information display area 316 is populated with information pertaining to Janet Smith. Within the patient information display area 316, various items of patient information are displayed. For example, the patient's age, sex, and date of birth, as well as overall assessments and statistics pertaining to the patient, may be displayed. An alerts display area 332 may display alerts pertaining to noteworthy medical events, upcoming medical events that are, or need to be, scheduled, important items of information, and the like. For example, alerts display area 332 indicates that Janet Smith was recently added to the diabetes registry. This might mean that Janet Smith was recently identified as belonging to a patient population segment that includes patients diagnosed with diabetes.

A longitudinal record display area 334 may display items of information from the patient's longitudinal record. The longitudinal record may include an aggregation of healthcare-related information associated with the patient. Such information may date all the way back to the patient's birth. The longitudinal record may chronicle illnesses, conditions, procedures, surgeries, medications, allergies, laboratory tests and results, and any other healthcare-related information associated with the patient over the course of the patient's lifetime. As shown in the longitudinal record display area 334, various categories of information may be expanded and collapsed to provide a desired level of detail. For example, a “conditions” list may be expanded to view medical conditions associated with the patient. Notifications may be provided for new items. In the longitudinal record display area 334, the newly-diagnosed condition of diabetes corresponds to the alert for the newly-added diabetes registry in the alerts display area 332. A “medications” list may also be expanded and collapsed. Additionally, a user may select a particular item to view item details. For example, the “medications” list includes the name and dose for a prescription medication. A user may select one of the medications listed to view additional information, such as a start date for the medication, duration over which the medication should be taken, frequency, special instructions, and the like. Similarly, a “procedures” list, “allergies” list, and “labs” list may be expanded and collapsed, and individual items within those lists may be selected in order to view a desired level of detail.

A care team display area 336 may display a care team associated with the patient. Here, Janet Smith's care team includes Dr. Larry Thomas as a primary care physician, Dr. Julia Harris as a cardiologist, and Cindy Miller as a care manager. These titles may be provided to the user role component 220 of FIG. 2 for purposes of determining a role associated with a particular user with respect to Janet Smith. Additionally, when a user, such as Dr. Larry Thomas, logs into an application supporting the care management interface 300, his login credentials may be associated with user role information that is provided to the user role component 220 of FIG. 2.

Also within the patient information display area 316 is, in embodiments, a menu from which a user may select a menu option corresponding to a desired type of information about the patient. These menu options may include an overview, Care Management (CM) tracking, documentation, registries, provider relationships, care plan, and clinical information. CM tracking may refer to the ability of a healthcare provider to follow and/or track the care of a particular patient by means of the patient's care plan (e.g., a physician may track a patient's care by viewing the orders, medications, goals, etc. included in that patient's care plan). Within the patient information display area 316, a care plan indicator 318 has been selected. Consequently, the care plan 320 is displayed in the patient information display area 316. The care plan 320 may include any number of care plan items. As mentioned above, the particular care plan items and the particular content within those items that are presented to the user may be customized for the user. The care plan items included in the care management interface 300 fall into a number of categories, including an activity category 322, a labs and measurements category 324, a medication therapy category 326, an education category 328, and an appointments category 330. Each of these categories may be expanded and collapsed, as desired by a user. Additionally, new care plan items within any given category may be manually added by a user, such as by clicking an “add” button within the desired category. The added care plan item may correspond to new patient information, such as information acquired during a present encounter with the patient. Additionally or alternatively, the added care plan item may correspond to an older care plan item that was not automatically presented, but that the user wishes to view. Such manual additions and/or modifications by a user may be observed and analyzed in order to refine the logic implemented by the customized care plan service 210.

The care plan items displayed in the care plan 320 are customized for Dr. Larry Thomas to provide information that is particularly relevant in his treatment of Janet Smith. As described above, this customization may be based on, among other things, a healthcare role associated with Dr. Larry Thomas. The activity category 322 includes care plan items that provide a high-level overview of the exercise and diet activities associated with the patient. The labs and measurements category 324 provides the labs and measurements currently being monitored for Janet Smith, as well as the target ranges for each lab or measurement. The care plan items in the medication therapy category 326 display the name, dose, and frequency associated with a particular medication therapy. The education category 328 includes care plan items that provide a high-level overview of the patient education that is relevant to Janet Smith. Finally, the appointments category 330 may be expanded to view upcoming appointments for Janet Smith.

It should be understood that these categories are merely exemplary and are not intended to limit the scope of the present invention. The particular categories and care plan items included in the care management interfaces 300 and 400 of FIGS. 3 and 4, respectively, are chosen for illustrative purposes only.

A comparison of the care management interface 300 of FIG. 3 with the care management interface 400 of FIG. 4 may be helpful in understanding how a personalized patient care plan might be customized for different users associated with different healthcare roles.

The care management interface 400 includes many of the same basic features found in the care management interface 300. For example, a user login indication 410 shows that a user has logged in as Cindy Miller. The user has selected a worklist tab 412, which causes a worklist display area 414 to be displayed. Within this worklist display area 414 is a list of new persons 413 associated with Cindy Miller. Janet Smith has been selected, as indicated by reference numeral 415, and as a result, patient information display area 416 is populated with information pertaining to Janet Smith. As in the patient information display area 316 of FIG. 3, within the patient information display area 416, various items of patient information are displayed, including the patient's age, sex, date of birth, and overall assessments and statistics pertaining to the patient. The alerts display area 432, longitudinal record display area 434, and care team display area 436 are similar to the corresponding display areas in the care management interface 300 of FIG. 3. Thus, the discussion of these display areas is not repeated here. Nonetheless, it should be understood that display areas different from, or in addition to, the display areas included in FIGS. 3-4 may be included in various care management interfaces, yet still fall within the scope of the present invention. Similarly, care management interfaces may include fewer display areas than those described above without departing from the scope of the present invention. Additionally, while FIGS. 3-4 show the same basic display areas presented to two different users, it will be understood that one user treating a patient may be presented with one set of display areas, while another user treating the same patient may be presented with a different set of display areas. Furthermore, while the lists of new persons 313 and 413 include the same patients, it will be understood that different users may have different patients included in this list.

Turning now to the care plans of FIGS. 3-4, the care plan 420 of FIG. 4 differs from the care plan 320 of FIG. 3 in a number of aspects. As indicated in the care team display area 436, Cindy Miller is a care manager for Janet Smith, and as previously explained, Dr. Larry Thomas is the primary care physician for Janet Smith. Thus, various differences between the care plan 320 of FIG. 3 and the care plan 420 of FIG. 4 may be attributed to customization of the care plan based on a healthcare role associated with a particular user.

Before explaining how the care management interfaces 300 and 400 are customized for a primary care physician and a care manager, respectively, it may be helpful to provide background information regarding the role of a care manager and the types of services that care managers provide. Care management, generally, aims to provide patient-centric services for the purpose of coordinating and facilitating healthcare activities across multiple healthcare providers and healthcare venues. For example, care managers may serve as a liaison between a patient and the healthcare system, such as by coordinating and facilitating a patient's healthcare activities at home, at an outpatient facility, at an acute care facility, at a post-acute care facility, and at any other healthcare-related venue. Goals of care management include, among other things, optimizing patient health status, healthcare quality, and healthcare costs.

Care management may be particularly useful for a patient having numerous and/or frequent healthcare-related events across multiple healthcare venues. Such patients may have difficulty managing a schedule of appointments, medications, action items, and other healthcare tasks, and may therefore benefit from the assistance of a care manager. Care managers may reach out to patients, such as by calling and/or visiting, to ensure the patient is attending scheduled appointments, taking medication as prescribed, engaging in recommended healthcare activities, and the like. For example, a care manager may call to ask a patient how a recommended diet and exercise regimen is going. The care manager may further confirm that the patient is properly taking medications (e.g., correct drug, dose, and time). If the patient is not doing so, the care manager may recommend tips for staying on track. In this way, the care manager provides person-centric care services on a regular, ongoing basis. Because the care manager maintains close personal contact with a patient, the care manager may be interested in learning and documenting items pertaining to the patient's mental, social, and emotional wellbeing. The level of interest that a care manager has in such information might be greater than a physician's level of interest with respect to any given patient, as a care manager may engage in frequent, extensive contact with the patient, while the physician may see the patient only occasionally for a limited period of time.

A care manager may further facilitate communications between a patient and various care providers. For example, a care manager may assist the patient in understanding information communicated by a clinician. Similarly, a care manager may communicate certain information to a clinician, in order to ensure the clinician is receiving information needed to appropriately treat the patient. Additionally, a care manager may assist in reducing healthcare costs to the patient, costs to the patient's insurer, and costs within the healthcare system, generally. For example, the care manager may assist a patient in choosing a provider within the patient's insurance network.

At least several specific care manager roles may fall within the scope of the general “care manager” title. For example, a care manager might specifically be an episodic care manager. An episodic care manager may be assigned to patients that have experienced a particular medical episode, and the duration of the care manager's services may be limited to a predefined period of time. For example, an episodic care manger may be assigned to patients who have experienced heart attacks, and may provide care management services for a specified period of time following the heart attacks. Other care manager roles include longitudinal care managers. Longitudinal care managers may provide care management services to a wide variety of patients and may provide those services over an extended, undefined period of time. A longitudinal care manager might be associated with a primary care physician and may be assigned to patients of that primary care physician. A single care manager might be an episodic care manager for one patient and a longitudinal care manager for another patient. In this way, as mentioned above, a healthcare role associated with a user, such as a care manager, may vary from one patient to the next.

This brief overview of a care manager role is included for the purpose of providing context for the present invention, which may customize a care plan for a care manager role. The above discussion is not intended to provide a comprehensive explanation of a care manager role, and it will be understood that additional responsibilities and activities associated with a care manager role may influence the customization of a care plan for a care manager, in accordance with embodiments of the present invention.

Turning now to the comparison of the care management interfaces 300 and 400, customized for a physician and care manager, respectively, several differences are illustrated. Generally, the care plan 420 that is customized for a care manager includes detailed information pertaining to a patient's daily activities, with a particular focus on interactive touch points between the care manager and the patient. Because the care manager's responsibilities include direct, regular communications with the patient, care plan items presented to the care manager include information relevant to those direct, regular contacts. Specific examples of this are discussed below.

Initially, the care plan 420 includes care plan items for current notes 438 and action items 440, which are not included in the exemplary care plan 320 for the primary care physician. The current notes 438 care plan item enables the care manager to review recently-recorded notes regarding the patient. Such notes may detail conversations with the patient, which may aid the care manager in keeping track of frequent patient communications. For example, the care manager can quickly review the current notes 438 and be reminded that the patient is struggling to remember to monitor her blood sugar regularly. This piece of information may serve as a touch point for future contact with the patient. The physician may not have time to review such detailed notes for each patient the physician treats. Instead, the physician may benefit from the high-level outline of care plan items presented in care plan 320, where more detailed information may be obtained by simply selecting one of the care plan items. In embodiments, the physician may view the care manager's current notes 438, if desired. The action items 440 care plan item may include current action items for the care manager. For example, action items might include scheduling an appointment for a patient, calling a patient, calling a patient's family, providing educational materials to the patient, as well as a number of other action items. Thus, when a care manager calls a patient, the care manager may review both the current notes 438 and action items 440 care plan items to determine touch points, or talking points, for the conversation.

Both care plan 320 and care plan 420 include an activity category for care plan items. The physician's activity category 322 briefly summarizes activity relevant to the patient, including “increase activity” and “diet” care plan items indicating the fact that the patient has been instructed to increase her activity, and specifically to walk 5000 steps daily, as well as to monitor her diet, and specifically to limit her caloric intake to 2200 calories daily. The care manager's activity category 422 includes this same information, but includes additional information, as well. Because the care manager regularly communicates with the patient, the care manager may be in a position to influence the patient's activity and diet by offering suggestions and support as the patient implements lifestyle changes. Thus, the diet care plan item in the care manager's activity category 422 includes content relating to food logging and reviewing diet recipes. The patient's primary care physician is unlikely to assist a patient in logging food intake or researching recipes, so this information may not be relevant to the physician's treatment of the patient.

Both care plan 320 and 420 also include a labs and measurements category 424. Again, the care manager's care plan 420 includes information relevant to the patient's daily activities, upon which the care manager may have some impact. The patient's daily monitoring of her blood pressure may be relevant to the care manager's treatment of the patient. Although not illustrated here, in embodiments, the physician's labs and measurements category 324 may include a more detailed report of the orders and results for various labs and measurements, as compared to the care manager's labs and measurements category 424. The physician may find a particular item of data from these reports to be relevant to treatment of the patient, while the care manager may be interested only in a high-level overview indicating whether the results from the lab or measurement were generally good or generally bad with respect to the patient's health. Also not illustrated here is the fact that the care manager may have limited editing capabilities with respect to the care plan items included in the labs and measurements category 424. For example, the care manager may not be permitted to modify lab measurements. Such modification may only be permitted by a physician or lab technician. Similarly, the care manager may not be permitted to place lab orders. In this way, access and/or edit permission settings may be dependent on a role associated with a user. For example, certain care plan items may be associated with a “read only” setting for the care manager.

Continuing on with respect to the care plan 320 and the care plan 420, both include a medication therapy category 326 and 426, respectively. The care plan item included in the care manager's medication therapy category 426 includes a note to assist the client in setting a daily reminder for performing glucose checks. Again, this activity may not be the type of activity with which a physician would usually assist, but it may be the type of activity with which a care manager would assist. Thus, as mentioned, the care manager's care plan 420 includes items upon which the care manager may have an impact. Along these same lines, the care manager's care plan 420 may include care plan items corresponding to a medication schedule for the patient. This schedule might include the particular medications a patient is prescribed to take at a particular time of day. The care manager may use this care plan item to assist the patient in taking the proper medication at the proper time.

As with the labs and measurements category, in embodiments, the physician's care plan 320 may include more detail regarding the medications prescribed for the patient, as compared to the care manager's care plan 420. For example, the care manager may only need information pertaining to the name, dose, and frequency of the medication for purposes of treating the patient, while the physician may need detailed information regarding allergies, interactions with other medications, special instructions, and the like. Also similar to the labs and measurements category, the access and/or edit permission settings associated with the medication therapy category may prevent a care manager from adding, removing, or modifying care plan items relating to the patient's medication therapy. For example, a care manager may not be permitted to add a new order for a medication.

The education categories 328 and 428 include care plan items pertaining to educational activities for the patient. The care plan items in the physician's care plan indicate that the patient has been instructed to learn about healthy eating, counting carbohydrates, and exercising. The care plan items in the care manager's care plan include specific action items associated with these topics. For example, the care manager's care plan items indicate that the care manager is going to assist the patient in identifying healthy eating habits and identifying an exercise program that is suitable for the patient.

Finally, the appointments categories 330 and 430 may include care plan items corresponding to upcoming appointments for the patient. In some instances, a physician may not wish to view this category at all, as the patient's upcoming appointments may not be particularly relevant to the physician's treatment of the patient. In other instances, however, the appointments category 330 may be helpful to the physician, as the physician may want to confirm that the patient is scheduled for a follow-up appointment, a consultation with a specialist, or other particular appointments relevant to the physician's treatment of the patient. The appointments category 430 for the care manager may include care plan items relating to appointments that need to be scheduled. For example, the care manager might assist the patient in scheduling appointments, and as such, the care plan items in the appointments category 430 may correspond not only to upcoming appointments, but also to appointments that have yet to be scheduled. The care manager's appointments category 430 may also include care plan items corresponding to a reminder for the care manager to contact the patient before the appointment and review information regarding the appointment (e.g., time, duration, location, required documentation, subject matter of the appointment, special instructions, questions).

As has been mentioned, the care plans 320 and 420 are exemplary only. Additional categories and care plan items are included within the scope of the present invention. For example, a care plan may further include a healthcare utilization care plan item. Such an item may correspond to a healthcare utilization history for the patient, which may indicate a number of patient visits to healthcare providers outside of the patient's insurance network, as compared to a number of visits to healthcare providers within the patient's insurance network. The healthcare utilization history may also include the patient's history of visiting an emergency healthcare facility, as compared to a non-emergency healthcare facility. It may be determined that some of the emergency healthcare facility treatment could have been provided by a non-emergency healthcare facility, and as such, the costs incurred by visiting the emergency healthcare facility could have been avoided. This history may be useful to a user, such as a care manager, in identifying unnecessary healthcare costs incurred by the patient and/or the patient's insurer. As mentioned, one role of the care manager is reducing costs within the healthcare system and, as such, the healthcare utilization data may be relevant to the care manager's treatment of patients.

Furthermore, it may be determined that healthcare data corresponding to a patient goal is relevant to treatment of the patient by the care manager, as well as other users. Patient goals and corresponding care plan items will be discussed in more detail below, but based on the preceding discussion, it should be understood that a patient goal may be relevant to a care manager, because the care manager may assist the patient in identifying specific action items the patient might take in order to achieve the goal. Such healthcare data may or may not be deemed relevant to a primary care physician. For example, the primary care physician might be interested in understanding the patient's goals at a high level, but might not have time to review each and every care plan item corresponding to an action item in pursuit of that goal.

It may further be determined that healthcare data corresponding to a prescription order is relevant to treatment of the patient by the primary care physician, as well as other users. As mentioned, this data might also be deemed relevant to the care manager's treatment of the patient, but the care manager might not have the ability to add or modify a care plan item corresponding to this data. By contrast, the primary care physician might have the ability to add and modify such items.

Other care plan items might include information regarding regulatory requirements. These care plan items may be determined to be relevant to users responsible for implementing the regulatory requirements and, as such, may be presented to those users.

As may be inferred from the preceding discussion, care managers may play a significant role in personalizing care plans for a particular patient. The set of healthcare data that is populated as a set of care plan items in a personalized patient care plan may have been collected for that patient over time. The care manager may also obtain specific pieces of information pertaining to the patient's mental, emotional, and social health, which may not be derived from specific healthcare data collected across healthcare venues. This information may help the care manager to further develop and personalize the care plan for the patient. This personalization may assist all healthcare providers in better serving the unique needs of the patient. For example, as mentioned above, the customized care plan service 210 may automatically determine that a diabetic patient needs to monitor his diet and begin an exercise regimen. But suppose the patient Janet Smith has set a goal to increase her health so that she can travel to her granddaughter's graduation. This personal goal is not something the customized care plan service 210 can automatically determine. Thus, a care manager can provide this type of information to the customized care plan service 210, and the care plan for the patient can be more closely tailored to the patient's unique situation. The care manager may also obtain information regarding the patient's preferences with respect to medical treatment. For example, the patient may object to blood transfusions for religious reasons. The care manager may provide this information to the customized care plan service 210 such that the information is automatically populated within the patient's personalized care plan that is presented to other healthcare providers.

While the preceding discussion has emphasized the potential differences among care plans customized for users associated with various healthcare roles, it should be noted that some unified care plan items may be included in a personalized care plan for a patient, regardless of a healthcare role associated with a user. For example, a care plan item indicating that a patient is due for an annual flu shot may be included in the patient care plan, regardless of the user to whom the care plan is presented. This type of unified care plan item may be included in care plans for nearly all patients, as it may be deemed appropriate for almost all patients, subject to a limited number of qualifications. Thus, this unified care plan item may be presented annually, and then may be removed after the shot has been administered, until it is time for the next annual flu shot. Other unified care plan items that are included in the patient's personalized care plan, regardless of the healthcare provider to whom the plan is being presented, may be patient specific. For example, a care plan item indicating that a patient is pregnant is specific to that individual patient, but this information may be deemed relevant to treatment of the patient without regard to a particular healthcare provider or healthcare provider role.

The discussion above illustrates the ways in which care plans may be customized according to a particular context, such as a context for a specific patient, healthcare provider, time, healthcare event, healthcare venue, medical history, and the like. The care plan of the present invention may also be dynamic in nature. Details of this dynamic nature are described below.

In one aspect, the care plan may be continuously updated based on the most current healthcare data available for the patient. As the patient continues to engage in activities within the healthcare system and continues to interact with various healthcare providers, healthcare data for the patient may be generated and accumulated. For example, with each change event, such as a new healthcare provider, new healthcare venue, new patient condition, or any other healthcare event corresponding to a change from a previous patient state, new healthcare data may result. These new and/or changed data and corresponding care plan items may be reconciled with existing healthcare data and care plan items. Thus, as new content corresponding to change events is added, the reconciliation process may ensure that the new content is not repetitive or contradictory in view of existing content.

Additionally, updated healthcare data, which may be derived from activities of one healthcare provider, may be relevant to treatment of the patient by another healthcare provider. For example, suppose that one healthcare provider orders laboratory tests, the results of which may be relevant to treatment of the patient by a number of other providers. Thus, when the results of these laboratory tests are returned, care plan items corresponding to the tests and results may be automatically populated in the care plans presented to a number of the patient's healthcare providers. As used herein, automatically may refer to an event that occurs without user intervention. In other words, the patient's healthcare providers might not need to take any action in order for care plans presented to them to be automatically populated with the updated set of care plan items.

As a further example, consider again the situation in which a care manager calls a patient and learns that the patient has set a personal goal to become healthy enough to travel to her granddaughter's graduation. The care manager may add a care plan item corresponding to this patient goal to the patient's care plan. Based on this goal, the patient's care plan may be automatically populated with care plan items including patient action items for achieving the goal. Care plan items corresponding to healthy eating habits and an exercise regimen may be added to the patient's care plan. Based on these automatically generated care plan items, as well as on the care manager's personal knowledge and experience, the care manager may work with the patient to develop a diet and exercise plan to reach the patient's goal. Care plan items corresponding to specific aspects of this diet and exercise plan may be generated automatically, as described above, and/or manually. One or more of these new care plan items may be automatically populated in the care plan presented to another healthcare provider, such as the patient's primary care physician, in order to keep the healthcare provider informed of current happenings with the patient. For example, the primary care physician may review the exercise regimen and determine it is too strenuous for the patient's current state of health. Or the primary care physician may take the patient's weight loss goal into account when prescribing various medications, such as by avoiding prescribing a medication that is likely to cause weight gain as a side effect. In this way, the communication of information that is encouraged and facilitated by the dynamic care plans of the present invention may enable shared decision making and optimize care for the patient. Specifically, the relationship between the care manager and the patient may be leveraged to build upon the care plan that is automatically generated for the patient and provide a truly personalized care plan, which may then be shared with healthcare providers across a plurality of healthcare venues. The sharing of this care plan may lead to increased consistency in care for the patient across multiple healthcare providers associated with multiple healthcare roles and multiple healthcare venues. In this way, cross-continuum, multi-role care planning is facilitated. This sharing among healthcare providers and healthcare venues may further ensure that a patient receives the type of care appropriate for that particular patient at that particular time.

As illustrated by the examples above, the dynamic updating of the care plan may be triggered either by updated healthcare data, generally, or by specific care plan items that have been updated. In one instance, a healthcare provider might not be interacting with the patient's care plan, but may instead simply be communicating data for the patient across the network 216 (e.g., communicating laboratory results). This updated healthcare data may then result in the automatic updating of the set of care plan items included in the personalized patient care plan. In another instance, a healthcare provider might be viewing the patient's care plan and specifically adding, removing, or modifying a particular care plan item included therein, thereby providing an updated care plan item. Any combination of these activities may trigger the automatic updating of content included in the patient care plan that is presented to any number of healthcare providers. In any of these instances, the receiving component 218 of FIG. 2 may be configured to receive the updated information such that the care plan customization component 222 may generate a customized care plan that includes the most current patient information that is relevant to a particular healthcare provider.

It is important to note that this dynamic updating may occur across healthcare providers and/or healthcare venues. For example, the plurality of data sources 211 of FIG. 2 may not only contribute healthcare data relevant to a patient via the network 216, but may also be presented with the comprehensive care plans generated by the customized care plan service 210. Thus, when one data source associated with one healthcare venue provides updated healthcare data for the patient, all data sources included in the plurality of data sources 211 may be presented with a care plan that includes a care plan item corresponding to that updated healthcare data.

The dynamic characteristics of the care plans of the present invention may include not only the automatic population of updated patient care plans, but also the presentation of a message indicating a suggestion and/or recommendation to add a new care plan item. This message may be based on the healthcare role associated with the user, as well as any number of other factors. For example, a recommendation may be based on a patient population segment to which the patient belongs. As mentioned above, various healthcare data may be associated with patients belonging to a population segment of patients having diabetes. Upon diagnosing a particular patient with diabetes, care plan items corresponding to such healthcare data may be presented as recommendations to the user. As a further example, recommendations may be based on standards of care or best practices. In this way, the care plan may facilitate informed healthcare decisions made by the user. Additionally, a recommendation may be based on a patient goal indicated by a patient. In this instance, a message indicating a suggestion to add a new care plan item including a patient action item for achieving the goal may be presented. This suggestion may be based on a patient goal library, where frequent patient goals and associated action items may be stored. Patient progress may be tracked to determine which action items lead to success for patients having certain attributes. The library of patient goals and corresponding action items may be stored at data store 214 of FIG. 2.

A user may respond to the message indicating a suggestion and/or recommendation to add a new care plan item by accepting, rejecting, and/or modifying the suggestion. Upon accepting the suggestion, the care plan may be automatically populated with the new care plan item. The user's response to the suggestion may be used to refine the logic implemented by the customized care plan service 210, such as by learning when the suggested care plan item is actually relevant to a particular user.

In the same way that various healthcare data are deemed relevant to particular users, suggestions to add new care plan items may be presented only to those users to whom the new care plan items may be relevant. For example, a suggestion to add a prescription order may be presented to a primary care physician. Such suggestion may be based on the patient's medical history, present symptoms, allergy information, and any other information that is accessible to the customized care plan service 210 and that may be relevant to placing a prescription order. The suggestion to add a prescription order may be presented to the primary care physician, because, in part, the primary care physician may have the ability to approve and place such order. This suggestion might not be presented to a care manager, particularly if the care manager does not have the ability to approve and place such order. But a suggestion to add a care plan item corresponding to an educational program for the patient might be presented to the care manager, because the care manager could assist in identifying such program and enrolling the patient in the program. This care plan item might not be suggested to the primary care physician, because this might be outside of the scope of the primary care physician's responsibilities.

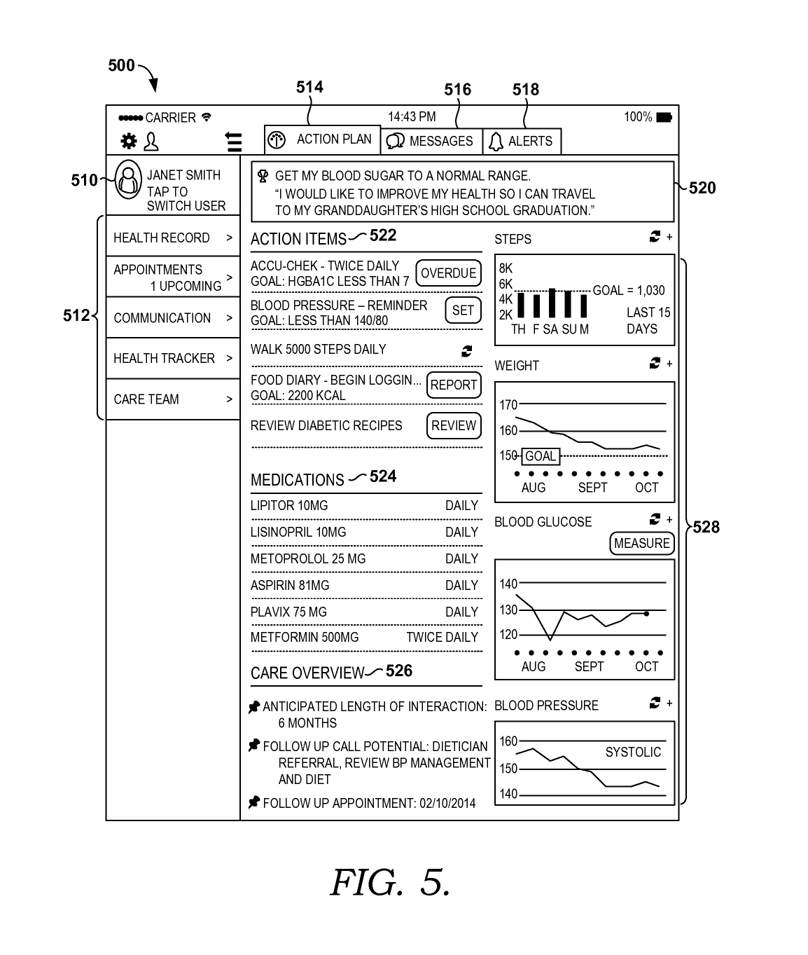

The discussion of customizable, personalized care plans has focused, thus far, on the presentation of care plans to healthcare providers. It should be noted, however, that the care plan information may also be accessible to the patient, as illustrated in the exemplary care management interface 500 of FIG. 5. The care management interface 500 may be part of a healthcare application and/or computer program available to patients, which may be accessed via any computing device available to the patient, such as a mobile phone, tablet, laptop, desktop, and the like. The user login indication 510 shows that a user has logged in as the patient Janet Smith. A plurality of menu options 512 enables a user to navigate the healthcare application in order to review items pertaining to the patient's health record, appointment schedule, communications, health tracker, and care team. The care management interface 500 may further include a number of tabs corresponding to additional content and/or views of content. An action plan tab 514 may include action items for the patient. A messages tab 516 may include messages to and from the patient, such as messages between the patient and the patient's care team. The alerts tab 518 may include alerts pertaining to upcoming appointments, overdue action items, new action items, and the like. These alerts may draw the patient's attention to upcoming items (e.g., an appointment) and/or items that need to be addressed (e.g., a medication that must be taken at a particular time).

As illustrated in the exemplary care management interface 500, the action plan tab 514 has been selected and, as such, items within Janet Smith's action plan are presented. Items within the action plan may correspond to care plan items for the patient. For example, a patient goal 520 is displayed at the top of the action plan. The patient goal may include a specific medical goal, such as maintaining the patient's blood sugar within a normal range, as well as a personal motivation pertaining to the goal, such as improving the patient's health so that she can travel to her granddaughter's high school graduation.

The exemplary action plan of the care management interface 500 further includes a list of action items 522, which may include a variety of tasks to be completed by the patient. For example, the list of action items 522 includes measurements that the patients must perform, such as blood pressure and blood sugar measurements that must be performed on a daily basis. The action items may further include diet and exercise items, such as diet and exercise targets. An exercise item on the list of action items 522 may be electronically linked to an exercise monitor, such as a pedometer, worn by the patient. Thus, the exercise item may be synchronized with the exercise monitor and automatically updated with data from the exercise monitor. A user may select a diet item in order to report progress with respect to the patient's diet, such as by logging the patient's caloric intake for the day. The list of action items 522 may further include miscellaneous items, such as an action item to review diabetic recipes. This action item may be linked to diabetic recipes, such that when the user selects the item, a list of diabetic recipes is presented to the user.

The action plan further includes a list of medications 524. This list may include all medications prescribed for a patient. Additionally or alternatively, the list may include new medications. The list of medications may include details such as a dose and frequency for the medication. The patient may use the list of medications 524 to track consumption of medication throughout the day. In embodiments, the list of medications 524 may include a checklist of individual medications, which the user may mark as completed throughout the day.

As shown in the exemplary care management interface 500, the action plan may additionally include a care overview section 526. This section may include noteworthy and/or timely pieces of information, such as upcoming communications, appointments, and the like. It may also include an anticipated length of interaction, such as an anticipated length of interaction with a particular healthcare provider. This may be relevant if the patient's interaction with a particular healthcare provider is focused on recovering from a specific healthcare-related event, such as a broken bone, surgery, or other procedure that has an anticipated recovery time.

The patient action plan may also include progress indications 528. These progress indications 528 may correspond to the patient's progress in a particular area, such as diet, exercise, and other measureable healthcare items. A particular item may be shown graphically over time.

As illustrated, the items included in the patient's action plan may correspond to care plan items for the patient. Specifically, the action plan may include items corresponding to care plan items over which the patient has control, such as medications, diet, exercise, monitoring of various measurements, and the like. Thus, the patient-specific view of care plan items may encourage the patient to proactively engage in the management of her health, track her progress over time, and communicate with her various healthcare providers. For example, the patient may be able to view various recommendations made by various healthcare providers. In embodiments, the patient may filter her care plan according to a particular healthcare provider. For example, if a patient wishes to review information corresponding specifically to her heart health, she may filter her care plan to review information associated with her cardiologist. The patient may have limited editing capabilities within her care plan. For example, a patient may be able to enter a personal goal that the patient has set, and the patient may be able to track her progress with respect to that goal, such as by logging her activity. This input provided by a patient may correspond to a change event that triggers updates to care plans presented to the patient's healthcare providers. Other information provided by the patient may trigger updates, such as an indication from the patient that she is unwilling to receive a blood transfusion for religious reasons. These types of treatment objections may be relevant to a healthcare provider's treatment of the patient in an emergency situation.

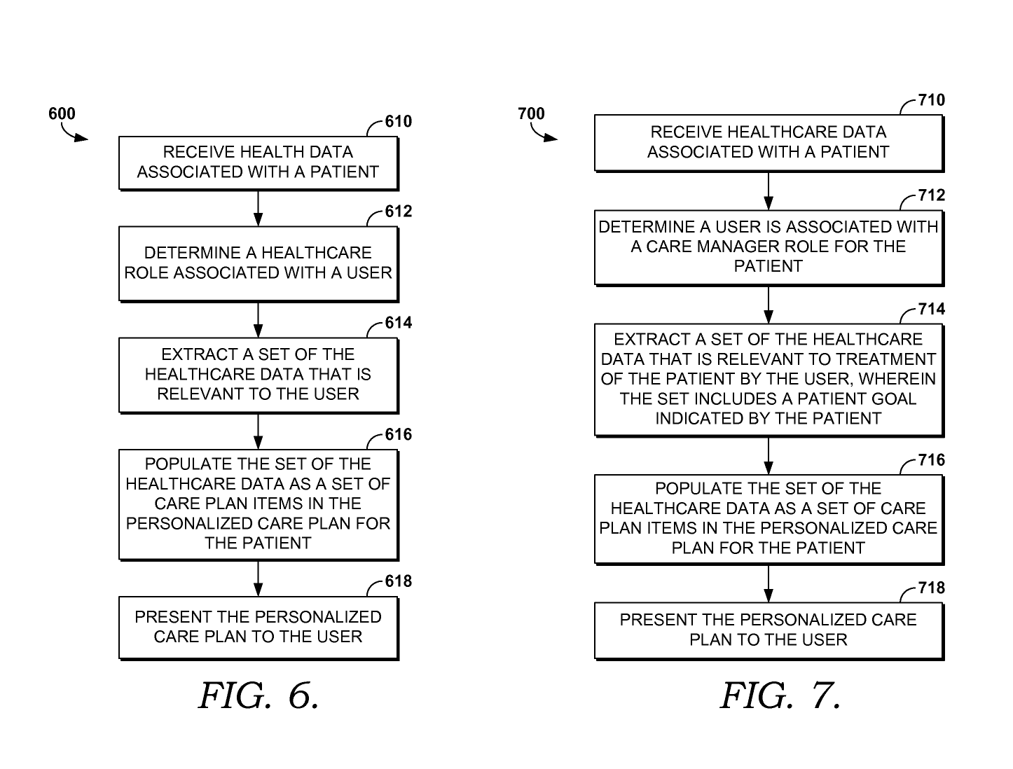

Turning now to FIG. 6, a flow diagram 600 of an exemplary method for providing a personalized care plan for a patient, where the care plan is customizable based on a healthcare role associated with a user, is illustrated. At step 610, healthcare data associated with a patient is received from a plurality of healthcare providers associated with a plurality of healthcare venues. A healthcare role associated with a user is determined at step 612. The healthcare role may correspond to a relationship between the user and the patient. Based on the healthcare role associated with the user, a set of the healthcare data that is relevant to the user is extracted at step 614. Extracting the set that is relevant to the user may include extracting a set that is relevant to treatment of the patient by the user. The determination of relevance may be based on a predefined content preference associated with the healthcare role associated with the user, a content preference associated with the particular user, and/or a set of best practices based on a condition associated with the patient, where the set of best practices is to be implemented by the user. In embodiments, the determination of relevance is based not only on the healthcare role associated with the user, but also on an identity of the patient, a patient history associated with the patient, a current healthcare event associated with the patient, and a current healthcare venue associated with the current healthcare event. At step 616 of the flow diagram 600, the set of the healthcare data is populated as a set of care plan items in the personalized care plan for the patient. The personalized care plan is then presented to the user at step 618.

In additional embodiments, the method illustrated by the flow diagram 600 may further include receiving updated healthcare data for the patient, where the updated healthcare data for the patient is received from one of the plurality of healthcare providers associated with one of the plurality of healthcare venues. At least one care plan item in the set of care plan items may be automatically updated based on the updated healthcare data.

In further embodiments, the method may include receiving updated healthcare data from a first healthcare provider of the plurality of healthcare providers, where the first healthcare provider is associated with a first healthcare venue of the plurality of healthcare venues. Based on the updated healthcare data, the set of care plan items included in the personalized care plan may be automatically updated to generate an updated personalized care plan. The updated personalized care plan for the patient may be presented to a second healthcare provider associated with a second healthcare venue. In this way, the dynamic updating and presenting of the personalized care plan for a patient may be shared across providers and across venues.

In still further embodiments, the method may include presenting a message indicating a suggestion to add a new care plan item to the personalized care plan for the patient. The suggestion may be based on the healthcare role associated with the user, as well as healthcare data for the patient. In addition to presenting a message indicating a suggestion to add a new care plan item, new care plan items may be automatically populated within the care plan. For example, a unified care plan item that is relevant to users associated with any healthcare role may be determined, and such unified care plan item may be automatically presented as part of the care plan. Additionally, a patient goal may be received, and based on that patient goal, as well as the healthcare data for the patient, an additional care plan item that includes a patient action item for achieving the patient goal may be automatically presented.

Turning now to FIG. 7, a flow diagram 700 of an exemplary method for providing a personalized care plan for a patient, where the care plan is customized for a user that is associated with a care manager role for the patient, is illustrated. At step 710, healthcare data associated with the patient is received from a plurality of healthcare data providers associated with a plurality of healthcare venues. At step 712, it is determined that the user is associated with a care manager role for the patient. A set of the healthcare data that is relevant to treatment of the patient by the user is extracted at step 714. This extracting may be based on a predefined content preference associated with the user's care manager role. The set may include a patient goal indicated by the patient. The set may further include a healthcare utilization history for the patient. Such healthcare utilization history may include a number of patient visits to healthcare providers outside of an insurance network for the patient. Additionally, the set may include a medication schedule for the patient. The medication schedule for the patient may include a prescribed medication and a predefined time at which the prescribed medication is to be administered to the patient. At step 716, the set of the healthcare data is populated as a set of care plan items in the personalized care plan for the patient. At step 718, the personalized care plan is presented to the user.

In embodiments, the method further includes receiving updated healthcare data for the patient, where the updated healthcare data is received from one of the plurality of healthcare providers associated with one of the plurality of healthcare venues. The updated healthcare data may be determined to be relevant to the treatment of the patient by the user, and as such, the set of care plan items included in the personalized care plan for the patient may be updated to generate an updated patient care plan. The updated personalized care plan may then be presented to the user.

In further embodiments, the method includes presenting a message indicating a suggestion to add a new care plan item to the personalized care plan for the patient. This suggestion may be based on the care manager role associated with the user and on the patient goal indicated by the patient. The new care plan item may include a patient action item for achieving the patient goal. Based on a user input indicating a command to add the new care plan item, the personalized care plan for the patient may be populated with the new care plan item. Then, the personalized care plan including the new care plan item may be presented to the user.

The present invention has been described in relation to particular embodiments, which are intended in all respects to be illustrative rather than restrictive. Furthermore, the present invention is not limited to these embodiments, but variations and modifications may be made without departing from the scope of the present invention.

What is claimed is:

1. Computer-readable media including computer executable instructions embodied thereon that, when executed by a computing device having a processor and memory, perform a method for providing a personalized care plan that is customizable based on a healthcare role associated with a user and that is shared among a plurality of healthcare providers associated with a plurality of healthcare venues, the method comprising:
receiving healthcare data associated with a patient, the healthcare data received from the plurality of healthcare providers associated with the plurality of healthcare venues;
determining the healthcare role associated with the user, the healthcare role corresponding to a relationship between the user and the patient;
based on the healthcare role associated with the user, extracting a set of the healthcare data that is relevant to the user;
populating the set of the healthcare data as a set of care plan items in the personalized care plan for the patient; and
presenting the personalized care plan to the user.

2. The media of claim 1, wherein the extracting the set of the healthcare data that is relevant to the user comprises extracting the set of the healthcare data that is relevant to treatment of the patient by the user.

3. The media of claim 1, wherein the extracting the set of the healthcare data that is relevant to the user comprises extracting the set of the healthcare data based on a predefined content preference associated with the healthcare role associated with the user.

4. The media of claim 1, wherein the extracting the set of the healthcare data that is relevant to the user comprises extracting the set of the healthcare data based on an identity of the patient, a patient history associated with the patient, a current healthcare event associated with the patient, and a current healthcare venue associated with the current healthcare event.

5. The media of claim 1, wherein the method further comprises:
receiving updated healthcare data for the patient from one of the plurality of healthcare providers associated with one of the plurality of healthcare venues; and
based on the updated healthcare data, automatically updating at least one care plan item in the set of care plan items.

6. The media of claim 1, wherein the method further comprises:
receiving updated healthcare data for the patient from a first healthcare provider of the plurality of healthcare providers, the first healthcare provider associated with a first healthcare venue of the plurality of healthcare venues;
based on the updated healthcare data, automatically updating the set of care plan items included in the personalized care plan to generate an updated personalized care plan;
presenting the updated personalized care plan for the patient to a second healthcare provider of the plurality of healthcare providers, the second healthcare provider associated with a second healthcare venue of the plurality of healthcare venues.

7. The media of claim 1, wherein the method further comprises, based on the healthcare role associated with the user and the healthcare data associated with the patient, presenting a message indicating a suggestion to add a new care plan item to the personalized care plan for the patient.

8. The media of claim 1, wherein the healthcare role associated with the user is a care manager role with respect to the patient, and wherein the extracting the set of the healthcare data that is relevant to the user comprises extracting an item of healthcare data corresponding to a patient goal.

9. The media of claim 1, wherein the healthcare role associated with the user is a primary care physician role with respect to the patient, and wherein the extracting the set of the healthcare data that is relevant to the user comprises extracting an item of healthcare data corresponding to a prescription order for the patient.

10. The media of claim 1, wherein the extracting the set of the healthcare data that is relevant to the user comprises extracting a set of best practices based on a condition associated with the patient, the set of best practices to be implemented by the user.

11. The media of claim 1, further comprising:
determining a unified care plan item that is relevant to users associated with any healthcare role; and
presenting the unified care plan item in the personalized care plan.

12. The media of claim 1, further comprising:
receiving a patient goal for the patient; and
based on the patient goal and the healthcare data for the patient, automatically presenting an additional care plan item that includes a patient action item for achieving the patient goal.

13. A computer-implemented method for providing a personalized care plan for a patient, the method comprising:
receiving healthcare data associated with the patient, the healthcare data received from a plurality of healthcare providers associated with a plurality of healthcare venues;
determining a user is associated with a care manager role for the patient;
extracting, at a computing device having a processor and memory, a set of the healthcare data that is relevant to treatment of the patient by the user, wherein the set of the healthcare data includes a patient goal indicated by the patient;
populating the set of the healthcare data as a set of care plan items in the personalized care plan for the patient; and
presenting the personalized care plan to the user.

14. The method of claim 13, further comprising:
receiving updated healthcare data for the patient from one of the plurality of healthcare providers associated with one of the plurality of healthcare venues;
determining the updated healthcare data is relevant to treatment of the patient by the user;
based on the determining the updated healthcare data is relevant to treatment of the patient by the user, automatically updating the set of care plan items included in the personalized care plan to generate an updated personalized care plan; and
presenting the updated personalized care plan to the user.

15. The method of claim 13, wherein the determining the set of the healthcare data that is relevant to the user comprises determining the set based on a predefined content preference associated with the care manager role.

16. The method of claim 13, further comprising:
based on the care manager role associated with the user and on the patient goal indicated by the patient, presenting a message indicating a suggestion to add a new care plan item to the personalized care plan for the patient, the new care plan item comprising a patient action item for achieving the patient goal;
based on a user input indicating a command to add the new care plan item, populating the personalized care plan for the patient with the new care plan item; and
presenting the personalized care plan including the new care plan item to the user.

17. The method of claim 13, wherein the set of the healthcare data that is relevant to treatment of the patient by the user further includes a healthcare utilization history for the patient, the healthcare utilization history for the patient comprising a number of patient visits to healthcare providers outside of an insurance network for the patient.

18. The method of claim 13, wherein the set of the healthcare data that is relevant to treatment of the patient by the user further includes a medication schedule for the patient, the medication schedule for the patient comprising a prescribed medication and a predefined time at which the prescribed medication is to be administered to the patient.

19. A computer system for providing a personalized care plan for a patient, the computer system comprising:
a receiving component that receives healthcare data associated with the patient;
a user role component that determines a healthcare role associated with a user;
a care plan customization component that extracts a set of the healthcare data that is relevant to treatment of the patient by the user and that populates the set of the healthcare data as a set of care plan items in the personalized care plan for the patient; and
a presentation component that presents the personalized care plan to the user.

20. The computer system of claim 19, wherein the receiving component is further configured to receive updated healthcare data for the patient, the updated healthcare data received from a plurality of healthcare providers associated with a plurality of healthcare venues, wherein the updated healthcare data are used to automatically generate an updated personalized care plan.
